(19) United States
(12) Patent Application Publication
(10) Pub. No.: US 2025/0162847 A1
(43) Pub. Date: May 22, 2025

(54) LIFTING DEVICE AND METHOD FOR FORMING A LIFTING ASSEMBLY FROM INDIVIDUAL LIFTING DEVICES

(71) Applicant: MAHA Maschinenbau Haldenwang GmbH & Co. KG, Haldenwang (DE)

(72) Inventor: Anton KNESTEL, Hopferbach (DE)

(21) Appl. No.: 18/838,413

(22) PCT Filed: Feb. 20, 2023
(86) PCT No.: PCT/EP2023/054151

§ 371 Date: Aug. 14, 2024

(30) Foreign Application Priority Data
Feb. 22, 2022 (DE) 10 2022 201 848.6

(51) Int. Cl. B66F 9/075; H04W 4/40; H04W 72/541

(52) U.S. Cl. CPC B66F 9/07581; H04W 4/40; H04W 72/541

(57) ABSTRACT

Method for wirelessly coupling at least two lifting devices in order to form a lifting assembly comprising the at least two lifting devices. The method can involve establishing a communication connection between a first lifting device and a mobile storage unit, transmitting the identification code which is stored in the first storage device of the lifting device to the mobile storage unit, disconnecting the communication connection between the first lifting device and the mobile storage unit, establishing a communication connection between an (N)th lifting device and the mobile storage unit, transmitting the identification code which is stored in the first storage device of the Nth lifting device to the mobile storage unit, and receiving the identification codes which are stored in the mobile storage unit and storing the received identification codes in the second storage device of the (N)th lifting device.

The present application is a national stage entry of International Patent Application No. PCT/EP2023/054151, filed Feb. 20, 2023, which claims the benefit of DE 101022201848.6, filed Feb. 22, 2022, which is hereby incorporated herein by reference as if set forth in full.

The present patent application relates to a lifting device which can preferably be a lifting column and particularly preferably a mobile lifting column, wherein a plurality of lifting devices can be coupled or connected to form a lifting assembly or a lifting installation having two or more lifting devices. Furthermore, the present patent application also relates to a method for forming a lifting assembly which offers, inter alia, increased safety and user friendliness when coupling a plurality of lifting devices. The lifting devices are preferably self-supplied in terms of energy, for example by means of a battery, and the individual lifting devices within the lifting assembly are likewise preferably connected to one another via a wireless communication connection or a radio network for data exchange or for communication.

The assembly of a lifting assembly is very flexible and differently configured lifting assemblies having a plurality of lifting devices can be assembled. The total number of lifting devices which are used for assembling a lifting assembly can be very different between i=2 . . . N. In one example of many for the flexible assembly of a lifting assembly, a total number of twelve lifting devices (any other number is possible) can be assumed, which can then be coupled in this example to form two different lifting assemblies each having six lifting devices, to form a single lifting assembly having all 12 lifting devices (or less) or to form three different lifting assemblies having four lifting devices. Many further configurations are conceivable which are substantially limited by the number of available lifting devices and can each be tailored to the lifting task. Since the lifting devices can preferably be provided for lifting vehicles, for example a lifting assembly can be assembled in each case depending on the number of axles or the number of wheels of the vehicle to be lifted. For the sake of completeness, it should be mentioned that a single lifting device can of course also be used (alone). If lifting devices are not used for a task, they remain unused in that they are not integrated into the lifting assembly.

The lifting devices are known in advance with regard to their mechanical construction and can have various shapes or configurations. Ideally, they are configured in such a way that a vehicle can be received and lifted on the wheels with a fork. However, there are also systems in which the receiving elements act on the frame, for example in rail vehicles.

A lifting device usually comprises a chassis, a lifting mast and a lifting carriage. The lifting carriage can be moved by an electric motor. This generally takes place hydraulically; alternatively, threaded spindles or by means of ball screw spindles are also known.

In addition, the known lifting devices can have control elements or a control device arranged on the lifting mast, by means of which a control is made possible, such as, for example, driving commands, inter alia driving up and down, and by means of which pairing/coupling processes can also be controlled.

In addition to the self-operated lifting devices, power-supply-operated lifting installations are also known which are connected to one another and to the power supply via a cable set. The assembly (connecting, coupling or pairing) of a lifting assembly from a plurality of lifting devices is defined here by the cabling. The advantage of a mobile (i.e. in particular self-supplied in terms of energy) lifting device is somewhat restricted by the necessary cabling. Operation without a sufficient power connection is not possible at all.

This disadvantage is avoided by lifting columns which are self-supplied in terms of energy, for example preferably battery-operated. A battery-operated system can operate without a power connection and can be charged from time to time at a standard socket. In systems without a rechargeable battery, the high power requirement during the lifting operation has to be covered by the power supply.

Furthermore, lifting assemblies can also be formed by means of a data cable connection and are known in advance. Here too, however, the full flexibility of mobile lifting devices is restricted by the pairing by means of data cable, or the full flexibility is not usable, since the data cable entails, inter alia, certain restrictions; for example physical restrictions with regard to the line length or the laying route.

The present patent application therefore relates in particular to lifting devices and lifting assemblies whose individual lifting devices communicate with one another wirelessly, for example via a radio network provided at the installation site, i.e. exchange data. For example, a driving command is input by means of a remote control or at a lifting column, and all lifting devices of the lifting assembly then exchange data with one another in a suitable manner in order to execute the driving command in a manner synchronized with one another at all lifting devices. The individual lifting devices behave jointly in the lifting assembly, i.e. in the state coupled or connected via radio, like a mechanically coupled lifting installation; for example by an upward or downward movement being executed at the same time and identically with regard to the route and direction of travel. This synchronized assembly behavior is very important with regard to safety and therefore both the radio communication and the formation of a lifting assembly have to meet high requirements with regard to safety.

It is known in advance with regard to the radio communication, inter alia, that the radio communication takes place within an assembly in the time slot (time slot) method in which each lifting device of the lifting assembly has been assigned a time/number defined during the connection/coupling in an order to which it can send data. The sending of data in accordance with the defined order takes place cyclically. Each lifting device usually sends in accordance with a predefined protocol.

For example, the data record sent cyclically by each lifting device can contain 8 bytes (or more or less), which in turn and for example can be divided as follows:
1) number of the data record
2) Identification Low Byte
3) Identification High Byte
4) column number or columns in the assembly
5) Status Byte
6) Status Byte
7) Height Information Low Byte
8) Height Information High Byte

The identification or the identification code (above bytes 2 and 3) can be, for example, a 16-bit value which is assigned once and unequivocally to each control in the factory. This means that an identification code only occurs once in all lifting devices. Code lengths other than 16 bits are of course also possible.

With regard to the coupling of individual lifting devices to form a lifting assembly, solutions which are already known in advance likewise exist. For example, it is possible for an operator to operate pushbuttons at each lifting column in order to select a radio channel via them. In this case, the operator has to ensure that each lifting column which is intended to be part of an individual lifting assembly is assigned the same radio channel in order to assemble the lifting assembly with the provided lifting columns as planned. It is disadvantageous that the assignment of individual lifting columns takes place manually and this is time-consuming and incorrect assemblies of a lifting assembly should be ruled out even more reliably in a desirable manner.

Furthermore, DE 112015001915 discloses a column lifting installation in which the lifting assembly is managed from a central control unit. Here, it would be desirable if an additional central control unit/device could be dispensed with in order to reduce the flexibility and complexity of the system.

Furthermore, EP3057903 discloses a method for radio communication in which a suitable free radio channel is first selected by machine. The column assembly is produced by an operator having to assign a unique key or code to each of the columns to be selected. The latter is complex and the input of the key by the operator could likewise be improved even further with regard to safety. If the key is assigned from a data carrier, it is necessary for each key to have its own data carrier with the corresponding coding.

From the statements above, it can be deduced that it would be desirable to provide a control device for a lifting device and a lifting device which make it possible to form a lifting assembly with less effort and even greater safety and also to provide a method which is suitable for producing a lifting assembly comprising a plurality of lifting devices/lifting columns with less effort and further increased safety. This object is achieved by the appended patent claims.

According to a first aspect, a control device of a lifting device is described. The control device can be an integral component of an already present controller or control module of the lifting device, for example by virtue of the technical properties described here being retrofitted by hardware and/or software, or the control device described here can be its own device (comprising hardware and/or software). The lifting device can also be referred to as a lifting column and it is preferably identical or similar with regard to the mechanical equipment of a known mobile lifting column. Particularly preferably, the lifting device is fed with electric current by its own energy unit.

The control device is provided in particular for setting up a lifting assembly which has a plurality of lifting devices which are connected to one another in the lifting assembly preferably by means of a radio communication connection for wireless/wireless data transmission. The radio communication connection can alternatively also be referred to as a radio connection, wireless communication connection or the like. The connection can be produced in a radio network which is present at the installation site of the lifting devices. The radio network can have a plurality of frequency bands (radio channels) via which a radio communication connection can be produced.

The control device can have a first storage device which is set up to store (electronic) data, wherein the data comprise at least one (unequivocal) identification code for identifying the lifting device. The unequivocal identification code is preferably defined from the factory and is preferably invariable. Furthermore, a second storage device can be provided which is set up to store (electronic) data, wherein the data comprise at least one or more identification codes of one or more other lifting devices. The data, inter alia identification codes which are or can be stored in the second storage device, are data which are received during operation and are variable or erasable. These data in the second storage device can be erased, for example, after the release or decoupling of a lifting assembly, with the result that, in the event of a new coupling operation, the second storage device is again ready to carry out the method described below or to participate in it.

It should be noted that the storage devices can comprise any known type of data memory and can be part of the control device or can be connected to the latter. The division into a first and second storage device preferably serves here for the (linguistic) discrimination of the data stored thereon and they can also be part of an individual storage device. It is merely important that the identification code of the own lifting device is stored beforehand and invariably, while further data, inter alia also identification codes of other lifting devices, are stored in a variable and also erasable manner. The memory management which is required for this purpose and/or the hardware configuration of one or more memories is known in advance.

Furthermore, the control device can have a transmitter/receiver device, wherein two separate devices can also be used for the sending and the receiving of data. The transmitter/receiver device is set up to send the identification code which is stored in the first storage device to an (external) mobile storage unit. This can take place via a wireless radio connection, preferably a short-range radio connection technology, such as Bluetooth®, NFC® or the like, or via a physical connection, for example by plugging the mobile storage unit into a corresponding port, for example USB, or via a temporarily produced cable connection. Furthermore, if present on the mobile storage unit, one or more and preferably all identification codes which are stored in the mobile storage unit can be received. The received data can then be stored by the control device or a subunit in the second storage device. The transmitter/receiver device can furthermore and preferably also be set up to receive or send incoming and outgoing radio communication with other hub devices via radio channels. For this purpose, the transmitter/receiver device can either have its own unit or this is configured overall in such a way that both the connection to the mobile storage unit can be set up and the radio communication with other lifting devices.

Furthermore, the control device can have a control device which is set up to trigger a transmission of identification codes between the mobile storage unit and the transmitter/receiver device of the control device in the event of a predetermined event, i.e. in an automated manner. This control device can likewise have the configuration that the identification codes stored in the first and second storage device can be sent via the (externally provided) radio network or a radio communication connection to the other lifting devices and/or to the radio network whose identification codes are stored in the second storage device. It is described in the claim that the control device is configured to transmit these data. This is preferably to be understood as meaning that the control device triggers or instructs the data transmission, while the transmission itself can then be executed, for example, by the transmitter/receiver device. The transmission of the identification codes from the two storage devices can take place in order to form a lifting assembly from the associated lifting devices and to terminate the coupling, i.e. to close the assembly with regard to the further accommodation of lifting devices. This can therefore preferably be carried out by the control device of the last lifting device to be accommodated in the lifting assembly. Alternatively or additionally, the sending of the identification codes stored in the first and second storage device can also take place to the radio network or a controller of the external radio network, so that the lifting devices assembled in the lifting assembly are stored there and are known. The latter is possible in particular in the time slot method, since in this case each lifting device of an identification code which is stored in the last selected lifting device in a storage device is then assigned a time slot for the communication with the other lifting assembly lifting devices and the lifting assembly can thereby be defined.

The configuration of the control device, as has been explained above, makes it possible to solve the abovementioned technical problem and in particular by virtue of each lifting device which is intended to be integrated into an assembly loading its predefined identification code onto an external storage medium when a user holds it, for example, close to a lifting device to be selected or physically connects it to the lifting device for data transmission. The identification code is unique and it is thus unmistakably defined which lifting device is intended to be integrated. Furthermore, the operator can simply approach each lifting device to be integrated and have the identification code read out on the mobile storage device, as a result of which all identification codes are captively collected on the mobile storage unit in order to assemble the lifting assembly with precisely these lifting devices at the end of the coupling operation. This also rules out in particular the possibility of an operator making an incorrect input during the selection of the lifting devices to be coupled, since the operator no longer makes any input at all with regard to the lifting device(s) to be selected and, as will be described in a preferred modification described below, the operator also does not have to select or input a radio channel for the lifting assembly. Such a control device, as presented here, therefore makes it possible for the effort for setting up an assembly, inter alia, to be able to be reduced and for the operational safety to be able to be increased further.

It is furthermore possible for a single mobile storage unit to be able to be used for many different coupling operations since its memory can be erased after a coupling operation has taken place or this can also take place in an automated manner.

In a preferred modification, the transmitter/receiver device can furthermore be set up to scan the frequency bands of a radio communication network or radio network and to automatically select a radio frequency band or a radio channel on the basis of predefined parameters/criteria in order to be able to exchange data wirelessly with one or more transmitter/receiver devices of other lifting devices via the selected radio frequency band. The radio network can be any desired network which is provided for the mobile/wireless communication (data exchange) and which can have a plurality of frequency bands or frequencies or frequency bands for setting up different radio channels. The selection of a radio channel by a lifting device or its control device or its transmitter/receiver device can take place for example on the basis of the minimum noise level of existing radio channels and the control devices of each lifting device can preferably be set up to scan radio channels which are available continuously or in a pulsed manner in terms of time. The predefined parameter/criteria for the automatic selection can be for example the noise level. It is also possible for a plurality of parameters to be linked, for example the noise level and information about which radio channels are still free.

Furthermore, the transmitter/receiver device can be set up to transmit the selected radio frequency band or the frequency (radio channel), i.e. preferably an identifier such as for example a predefined radio channel number, to the mobile storage unit.

As has already been explained above, the effort and the safety are further reduced or increased by the automatic selection of a radio channel since an operator also does not have to make any inputs whatsoever in this respect. A first lifting device of a plurality of lifting devices to be selected for the assembly can preferably automatically stipulate/select the radio channel and thereby stipulate the latter for the communication in the lifting assembly to be formed. This information with regard to the radio channel is preferably likewise transmitted with the identification code to the mobile storage device, with the result that this can be transmitted to all further lifting devices by data transmission from the mobile storage unit in an input-secure and unmistakable manner.

A further preferred modification of the control device can comprise the predetermined event for the transmission of the identification code being the prior activation of a coupling mode of the control device and/or the wireless or wired or physical connection of the mobile storage unit to the control device. The “and” combination is particularly preferred here, with the result that the coupling, i.e. the formation of a lifting assembly, is initially prepared by a command which can be input for example at a first lifting device provided for the lifting assembly; in particular by pressing a key, entering a screen, entering a remote control or the like. This first selected lifting device can then automatically select a radio channel which is intended to be used for the entire lifting assembly.

The connection to the mobile storage unit is for example an event which occurs as a result of an approach with the mobile storage unit to the transmitter/receiver device or a further unit which is provided specifically for this data connection. It is preferred here that the mobile storage unit is a transponder, a chip card, a tag, a mobile telephone or another mobile device which is suitable for producing a data communication connection to the control device of the lifting device and has a data memory. The data connection (communication connection) can be produced as described above and, in the case of a short-range radio communication protocol, the approach (within a preferably preset distance and depending on the technology used, NFC, RFID or the like) can already be defined as an event for the transmission of the identification codes. Other possibilities comprise the physical connection, for example of a USB stick as a mobile storage unit, or the additional pressing of a pushbutton or the like at the control device and/or the mobile storage unit.

The control device can therefore be operated in a highly automated manner and merely the start of assembly creating and/or the termination of such an operation can be predetermined by an operator input as a manual safety function. However, these can also be automated, for example by an approach or a connection of a mobile storage unit to a lifting device/control device which is not yet part of a lifting assembly or whose second storage device does not contain any identification codes being automatically evaluated as a start of coupling.

According to a further modification, the control device is set up to exchange data with other lifting devices (or their control devices) via a selected radio channel in the time slot method.

The time slot communication permits a very reliable data transmission between the individual lifting devices of a lifting assembly.

According to a further modification, the control device can have an input device at which a user of the lifting device can input control commands and the control commands input at the input device are transmitted via the selected radio channel to all other control devices which are integrated into the lifting assembly.

The input device can be of diverse configuration and can also comprise combinations of, for example, pushbuttons, switches, interactive screen user interface, remote control, mobile communication unit, for example smartphone, or the like. The operation can thus be designed to be flexible and to be able to be carried out as simply as possible. The input device can furthermore also be suitable for displaying or outputting data or information to the operator.

According to a further aspect, a lifting device having at least one control device according to at least one of the preceding aspects or modifications is described and, according to a further aspect, a system having at least two lifting devices set out above and at least one mobile storage unit is described. The advantages and modifications described above also relate to these aspects.

A further modification relates to a system, preferably as mentioned above, wherein an operator can integrate/couple/connect the at least two lifting devices into a lifting assembly having a radio connection between the lifting devices.

The operator can preferably activate a coupling mode at a first of the at least two lifting devices and connect the mobile storage unit to the first lifting device for communication. The activation of the coupling mode can also already take place by connecting the mobile storage unit to the lifting device or its control device. A control device of the first lifting device is further set up to transmit the identification code from the first storage device to the mobile storage unit, to select a radio channel and also to transmit it to the mobile storage unit, wherein the operator then disconnects the data connection of the mobile storage unit to the first lifting device and sets up a new data connection between the mobile storage unit and a further one of the at least two lifting devices, wherein the control device of the further/second lifting device is set up to transmit the identification code from the first storage device to the mobile storage unit and to receive the identification code of the first lifting device and the radio channel from the mobile storage unit and to store them in the second storage device. The data connection to the further lifting device is then disconnected by the operator and the coupling mode is preferably deactivated; for example by a corresponding input by the operator at the further/last lifting device. The identification codes which are stored in the first and second storage device are preferably subsequently transmitted by the control device of the further/last lifting device via the selected radio channel (here, as explained above, transmitted is preferably to be understood as meaning that the transmission is started or triggered by the control device, while the transmission itself can preferably also take place by the transmitter/receiver device or other units), with the result that all lifting devices which are connected in the assembly know the identification codes of the lifting devices which are arranged in the lifting assembly. Alternatively or additionally, the last lifting device or its control device can also transfer the collected identification codes of the lifting devices which are to be connected to the radio network, where each lifting device of the assembled assembly is assigned a number in the order of the cyclic data transmission per time slot method, with the result that only lifting devices whose identification codes have been transferred to the radio network can participate in the assembly communication, and these can also send data only at the assigned cyclically recurring times.

According to a further aspect, a method for wirelessly coupling at least two lifting devices in order to form a lifting assembly comprising the at least two (and up to N, wherein N is an integer number) lifting devices is described. Particularly preferably, the lifting devices are those as have been explained above in the above-described aspects and modifications.

The method can have the following steps and preferably in the following order:
Optionally: activating a coupling mode at at least one of the plurality of lifting devices; establishing a communication connection between a first lifting device and a mobile storage unit in a wireless or wired or wired manner; transmitting the identification code which is stored in the first storage device of the first lifting device to the mobile storage unit; disconnecting the communication connection between the first lifting device and the mobile storage unit; establishing a communication connection between an (N) th lifting device and the mobile storage unit in a wireless or wired or wired manner; transmitting the identification code which is stored in the first storage device of the Nth lifting device to the mobile storage unit; receiving the identification codes which are stored in the mobile storage unit and storing the received identification codes in the second storage device of the (N) th lifting device; disconnecting the communication connection between the (N) th lifting device and the mobile storage unit; terminating the coupling mode (if present) and transmitting the identification codes which are stored in the first and second storage device of the Nth lifting device. The transmission can take place to each lifting device whose identification codes are stored in the first or second storage device of the Nth lifting device and/or the transmission can take place to the radio network. For example, the latter option can be used in connection with a time slot communication for a radio network controller to assign a communication slot (slot) to each lifting device whose identification code has been transmitted to it, in which slot only this one assigned lifting device can set data in the lifting assembly communication of the selected radio channel.
If N should be greater than 2, further steps of the coupling between an N-1th, N-2th, etc. lifting device and the mobile storage unit are present, and corresponding transmission steps.
Furthermore, a preferred modification comprises the respective starting of the transmission of identification codes or storing taking place in the presence of a predetermined event and this can be for example the establishment of a communication connection between the respective lifting device and the mobile storage unit, particularly preferably in the case of near-field communication means, for example as a result of the approach of an operator who carries the mobile storage unit with him for the purpose of forming a lifting assembly to the control device of the respective lifting device to be selected.
Furthermore, a preferred modification comprises, if not already present, the provision of a radio communication network having at least one radio channel which is preferably automatically selected in one step by the first lifting device and the identifier or number of the selected radio channel is transmitted from the first lifting device to the mobile storage unit and stored there while they are connected to one another. In this case, in the further steps, in each case also in addition to the identification codes, the channel identifier is also transmitted from the mobile storage unit to each subsequently selected lifting device in order likewise to store this in the second storage device. It should be mentioned here that the selection of the lifting device preferably takes place in that an operator with the mobile storage unit successively approaches each lifting device with the mobile storage unit which is intended to be integrated into the lifting assembly. The first lifting device which the operator approaches should also preferably be the abovementioned first lifting device. Alternatively or additionally, the first lifting device can also be this at which the operator additionally activates a coupling mode. The Nth lifting device is in particular preferably identified as the last selected for the lifting assembly in that the operator inputs a command for terminating the coupling mode in a further step, for example by pressing a key at this lifting device.
After the end of the coupling mode, it can furthermore be preferred that the data which were used for the formation of the lifting assembly just created are deleted on the mobile storage unit. This makes it possible for a mobile storage unit to be able to be used for all lifting assemblies and therefore very great flexibility is made possible. The deletion of the memory of the mobile storage unit can also take place in that the last (Nth) lifting device transmits a corresponding command to the mobile storage device after the completion of the lifting assembly and therefore the mobile storage unit can be used universally directly subsequently for other lifting assembly assemblies. In the simplest case, the deletion can also take place manually by the operator.

As has already been explained above, the present disclosure can overcome the disadvantages of the methods and devices known in advance and permit a particularly reliable and inexpensive coupling of lifting devices into a lifting assembly.

### DESCRIPTION OF THE DRAWINGS

### BRIEF DESCRIPTION

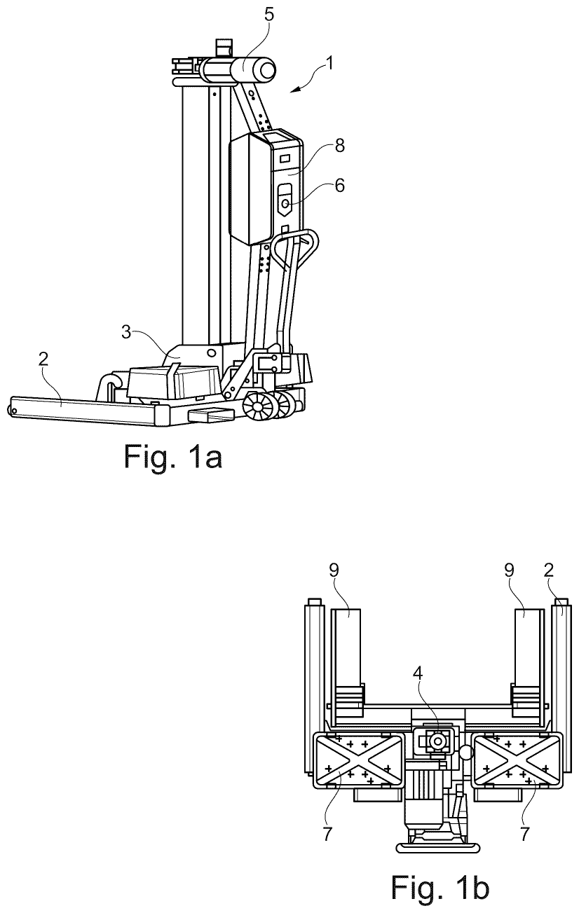

FIG. 1a shows the perspective of a lifting device according to the present disclosure.

FIG. 1b shows a plan view of a lifting device according to the present disclosure.

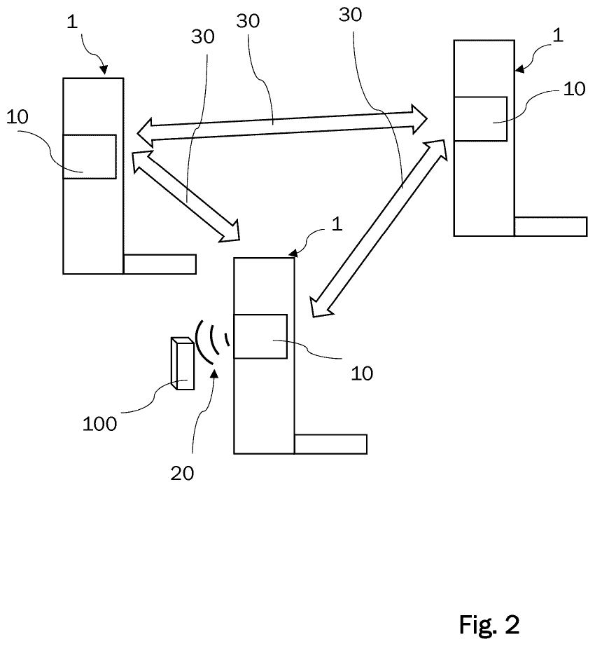

FIG. 2 schematically shows a lifting assembly comprising a plurality of lifting devices.

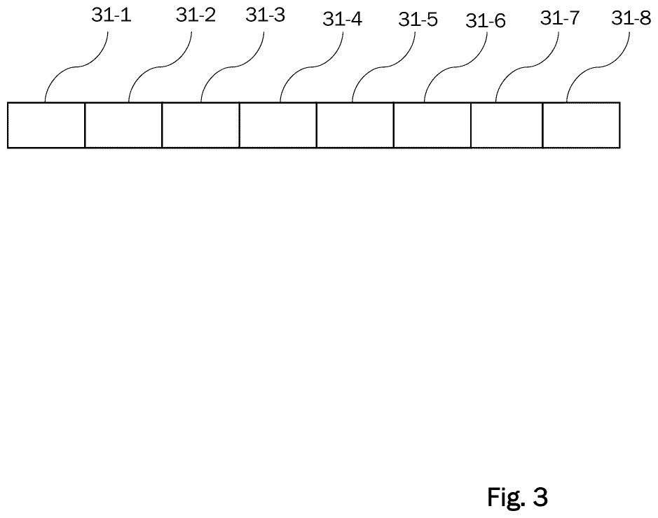

FIG. 3 shows the arrangement of time slots for a time slot communication method.

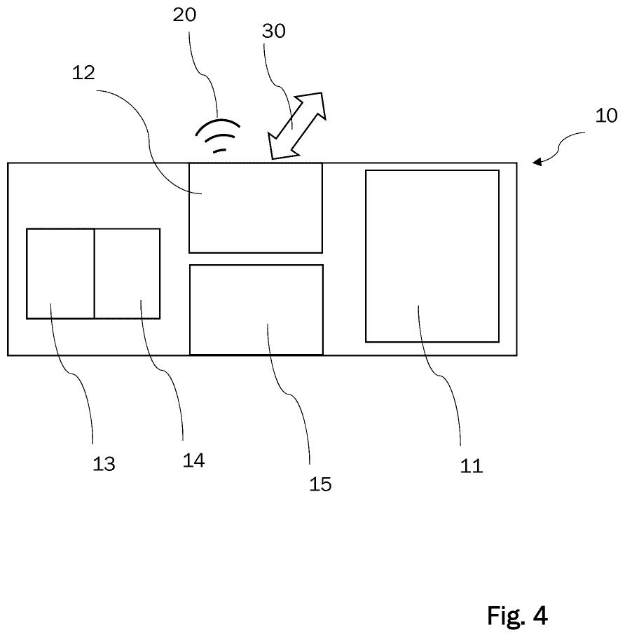

FIG. 4 shows a preferred control device according to the present disclosure.

### DETAILED DESCRIPTION OF THE FIGURES

FIG. 1a shows an individual lifting device 1 in the perspective, which in the present example can also be referred to as a mobile lifting column or “lifting column” for short. The lifting device 1 can be part of a lifting assembly (also referred to as lifting installation) which is assembled from a plurality of the lifting devices 1 shown. The lifting devices 1 of a lifting assembly communicate with one another via a radio network which is provided at the installation site of the lifting assembly. Furthermore, FIG. 1b shows the same lifting device from the bird's eye view.

The lifting device 1 is mounted on a mobile lower part 2. A lifting carriage 3 is mounted in a vertically movable manner on the lifting device 1, and load-receiving means (forks) 9 are arranged on the lifting carriage 3.

FIG. 1b shows a load-receiving means 9 for accommodating vehicle wheels. However, other load-receiving means are also available (not shown), for example for accommodating vehicles directly on the vehicle frame. In the lifting device 1 shown in FIG. 1b, a single fork 9 is used which has a limit switch (not shown) at the front end, via which limit switch the presence of the receptacle at the load point is signaled to the controller of the lifting device 1 (not shown).

The lifting spindle (not visible) is mounted in the lifting device 1, which lifting spindle is driven via the electric motor 5 and the transmission 4. The electrical energy for operating the lifting device 1 is supplied by a mobile energy supply unit 7, such as, for example, a battery or a fuel cell or the like.

A control module 8 is likewise arranged on the lifting device 1, which control module can preferably also have a control device 10 according to the present disclosure in an integrated manner. Operating elements 6, such as buttons, knobs, screen(s), can be arranged on the front side of the control module 8.

FIG. 2 shows a lifting assembly having here, purely by way of example, three lifting devices 1 (more or fewer lifting devices 1 can likewise form a lifting assembly according to the present disclosure) which are coupled to one another and which can communicate with one another via a radio network (not explicitly shown) and a radio channel 30 of the radio network which is symbolized schematically as double arrows between the lifting devices 1, i.e. inter alia exchange data or control commands. In such a lifting assembly, an operator can input control commands at a lifting device 1, for example for lifting the fork 9, and these are forwarded via the radio channel 30 to all further lifting devices 1, with the result that all individual lifting devices 1 in the lifting assembly implement the command in a synchronized manner.

Furthermore, FIG. 2 schematically shows the control device 10, described here, of each lifting device 1 which is set up inter alia to carry out a coupling operation in order to be able to form a lifting assembly from individual lifting devices 1. For this purpose, according to the present disclosure, a mobile storage unit 100 is additionally preferably used which is likewise shown schematically in FIG. 2, wherein the control device 10 and the mobile storage unit 100 each have a unit or device which can set up a communication connection 20 between the control device 10 and the mobile storage unit 100. In FIG. 2, this communication connection 20 is shown schematically by means of a short-range radio communication connection, for which NFC®, Bluetooth® or the like are suitable examples. In addition or instead, however, the mobile storage unit 100 can also be able to be coupled temporarily physically to the control device 10, for example via a cable connection or by means of plugging into a USB port or comparable means. The establishment of the communication connection 20 between the mobile storage unit 100 and a control device 10 can therefore be set up in a very flexible manner.

When the coupling of a plurality of lifting devices 1 to form a lifting assembly is concluded, communication with one another between the lifting devices 1 preferably takes place via the selected radio channel 30 in a time slot method (time slot). This is shown schematically in FIG. 3 which shows an arbitrarily selected number of time slots 31-1, 31-8 in which (i.e. during this time slot) the lifting device 1 which is predesignated for the respective time slot can send data. The order is repeated cyclically, with the result that each lifting device 1 can send data periodically at a fixed time. If fewer lifting devices 1 than time slots 31-1, 31-8 are present, individual time slots 31-1, 31-8 can also remain free. The occupation of the time slots 31-1, 31-8 can take place, as is known, for example via a controller of the radio network or by means of the order of the coupling of lifting devices 1 or the like.

Furthermore, each lifting device 1 preferably sends data in accordance with a predefined protocol. An example of this has already been shown above in the introduction, which example can preferably also be used for the present subject matter. Accordingly, each lifting device 1 sends eight bytes of data, particularly preferably and for increasing the data safety twice. The sending order or when a lifting device is allowed to send in each case is stored in the fourth byte in accordance with the protocol explained by way of example above.

FIG. 4 furthermore shows a schematic design of a preferably configured control device 10 according to the present disclosure. Thus, the control device 10 preferably comprises a transmitter/receiver device 12 which can exchange data with other lifting devices 1 or their control devices 10 via the radio network and radio channels 30. Furthermore, this transmitter/receiver device 12 can also have a subunit or the like in order to set up the data connection 20 to the mobile storage unit 100, which is shown schematically here by way of example via a short-range radio connection by means of the three curved lines. Furthermore, the control device 10 comprises a storage device which can comprise a first and a second storage device 13, 14. The first storage device 13 stores at least one identification code which is assigned in an unalterable manner to a single lifting device 1 during delivery or production or the like. The second storage device 14 can store other data and in particular data received from other lifting devices 1 by means of the transmitter/receiver device 12. A control device 11 or a control unit of the control device 10 executes control logics or programs which can be stored in the storage device. As a result, a configuration is provided whose technical advantages become even clearer by the explanations below.

Furthermore, the control device 10 can also have an input device 15 or can be connected to such an input device. The operating elements 6 and the input device 15 can preferably also be uniform or can be connected to one another.

The subunits/devices of the control device 10 are suitably connected to one another internally, with the result that data can be exchanged with one another. This can be implemented in a known manner, for example by means of a common arrangement on a circuit board or the like.

The control device 10 is preferably configured with the abovementioned subunits/devices in such a way that an operator can couple at least two lifting devices 1 in a lifting assembly by means of a radio connection/radio channel 30 between the lifting devices 1. In order to carry out the coupling, the operator can, in a preferred method, bring the mobile storage unit 100 into the proximity of or within radio range of the short-range radio reception of the connection 20 of a lifting device 1 which is intended to be integrated as a first lifting device 1 into a lifting assembly to be created. Alternatively, the operator can also establish a physical data connection 20 between the first lifting device 1 and the mobile storage unit 100. This operation then preferably activates a coupling mode (alternatively, this can also be started by an additional operator input) which results in the first lifting device 1 selecting a free radio channel 30 of the external radio network.

It should be noted that the lifting devices 1, when they are supplied with electrical voltage, can either continuously scan radio channels 30 or this can also take place only when the coupling mode is activated.

The selection of the radio channel 30 for the lifting assembly to be formed preferably takes place in an automated manner by the first lifting device 1 and can take place in accordance with predefined criteria. One possible criterion can be for example that the radio channel 30 with the lowest interference level is selected. After the selection of the radio channel 30 has taken place, its number or identifier is transmitted from the first lifting device 1 to the mobile storage unit 100. The first lifting device 1 likewise transmits the identification code stored in the first storage device 13 to the mobile storage unit 100. This takes place either so quickly that the operator does not have to be informed about the completion of the transmission. Alternatively or additionally, the completion of the transmission of the abovementioned data to the mobile storage unit 100 can also take place by a signal, for example optically or acoustically, by means of for example the operating elements 6 or the input device 15, with the result that the operator knows the precise time from when the connection 20 to the first lifting device 1 can be disconnected again.

Incidentally, it should also be mentioned here that the activation of a new coupling operation can also result in the control device 11 being able to output an erase command for old, preferably all old, data in the second storage device 14 and the mobile storage unit 100 before a command is given for the data transmission explained above. Alternatively, the resetting of the data in the second storage device 14 and/or the mobile storage unit 100 can also be realized in other ways; up to a manual erasure.

After the disconnection of the data connection 20 of the mobile storage unit 100 to the first lifting device 1, the operator will approach each further lifting device 1 to be selected, that is to say a second, third, fourth, fifth lifting device etc., with the mobile storage unit 100 in order likewise to set up a data connection 20 there between the mobile storage unit 100 and the respective further lifting device 1.

After the first lifting device 1 has already defined the radio channel 30, the corresponding identifier which is stored on the mobile storage unit 100 is transmitted to the further lifting devices 1 for information and is stored together with the identification codes already stored on the mobile storage unit 100 in the respective second storage device 14 of the respective lifting device 1/control device 10.

In other words, each control device 10 of each second, third, etc. lifting device 1 selected by the operator for the lifting assembly transmits its identification code to the mobile storage unit 100 and receives in each case the data already stored there, that is to say the identifier of the radio channel 30 selected by the first lifting device 1 and the identification codes of the previously selected lifting devices 1 already stored on the mobile storage unit 100. At the last lifting device 1 to be integrated in the lifting assembly, the radio channel identifier and also all identification codes of all previously selected lifting devices 1 are therefore stored in the second storage device 14 after these have been transmitted from the mobile storage unit 100. The operator can then terminate the coupling or pairing mode by means of a correspondingly predetermined operator input or this ends automatically after a predefined period of time and/or after a predetermined number of lifting devices 1 which are intended to be inserted into the lifting assembly. The last selected lifting device 1 (also referred to as Nth lifting device 1) then transfers/transmits all identification codes from the first storage device 13 (that is to say its own) and from the second storage device 14 (that is to say that of the previously selected lifting devices 1) to the radio network, where each lifting device 1 is assigned a time slot 31-1-31-8. The lifting assembly is therefore closed and ready for operation. Alternatively or additionally, the last lifting device 1 can also transmit all identification codes via the selected radio channel 30 to all lifting devices 1 whose identification codes are stored in their second storage device 14, with the result that these are informed about the lifting assembly participants.

As has already been explained, the lifting devices 1 interconnected/coupled/paired/connected to one another in the lifting assembly exchange their information/data in a known manner in the time slot method. The method described above ensures that the identification numbers of all lifting devices 1 operating in the assembly are known to one another. All commands such as “lifting” or “lowering” of the load are executed only by the columns with a known identification code. Furthermore, it is preferably possible, even in order to increase the safety of the data transmission even further, for data packets/data to be Hamming-coded and to be decoded by the receiving lifting devices 1 and the validity of the data record also to be checked there, for example by the control device 11. In the case of erroneous data, the result can then be that the movement of all lifting devices 1 in the assembly is stopped.

The method described above in which identification codes of lifting devices selected for the formation of a lifting assembly are collected by means of a mobile memory unit (for example an RFID transponder, NFC chip/card, etc.) and are (then) transferred or transmitted to the radio network and/or to all lifting devices 1 of the lifting assembly, a manual erroneous input or the like by an operator can be ruled out and the safety of the assembly formation can be increased once again. At the same time, the method also requires the least possible effort by the operator who assembles the lifting assembly, since the mobile memory unit 100 has to be carried substantially only once to the lifting devices to be selected.

1. A control device of a lifting device configured to set up a lifting assembly that comprises a plurality of lifting devices, which are connected to one another in the lifting assembly at least by means of a radio communication connection for wireless data transmission, the control device comprising at least
a first storage device, which is configured to store data, wherein the data comprise at least one identification code for identifying the lifting device;
a second storage device, which is configured to store data, wherein the data comprise at least one or more identification codes of one or more other lifting devices;
a transmitter/receiver device that is configured to send the identification code, which is stored in the first storage device, to a mobile storage unit and to receive one or more identification codes, which are stored in the mobile storage unit; and
a control device, which is configured to trigger a transmission of identification codes between the mobile storage unit and the transmitter/receiver device of the control device in the event of a predetermined event, and which is further configured to transmit identification codes which are stored in the first storage device and the second storage device.

2. The control device according to claim 1, wherein the transmitter/receiver device is further configured to scan radio frequency bands of a radio communication network and to select a radio channel on the basis of predefined criteria to exchange data wirelessly with one or more transmitter/receiver devices of other lifting devices via the selected radio channel, and configured to transmit an identifier of the selected radio channel to the mobile storage unit.

3. The control device according to claim 2, wherein the predefined criteria comprise an interference level of the radio frequency bands and the transmitter/receiver device is configured to select the radio frequency band with a lowest interference level as radio channel.

4. The control device according to claim 1, wherein the predetermined event for the transmission of the identification code is a prior activation of a coupling mode of the control device and/or a wireless or wired connection of the mobile storage unit to the control device .

5. The control device according to claim 4, wherein the control device is further configured to send the identification codes from the first and second storage device when the coupling mode has been deactivated.

6. The control device according to claim 1, wherein the control device is further configured to exchange data with other lifting devices via a selected radio channel using a time slot method.

7. The control device according to claim 1, wherein the control device has an input device at which a user of the lifting device can input control commands, and the control commands input at the input device are transmitted via the selected radio channel to other control devices, which are integrated into a lifting network.

8. The control device according to claim 1, wherein the control device is implemented in a lifting.

9. The control device according to claim 1, wherein the control device is implemented in a system comprising at least two lifting devices and at least one mobile storage unit.

10. The control device according to claim 9, wherein the at least two lifting devices are configured to be coupled in a lifting assembly by means of a radio connection between the at least two lifting devices, wherein the mobile storage unit is configured to communicate with a first lifting device, the control device of the first lifting device is configured to transmit the identification code from the first storage device to the mobile storage unit, to select a radio channel and to transmit an identifier thereof to the mobile storage unit, an operator can then disconnect the data connection of the mobile storage unit to the first lifting device and set up a data connection between the mobile storage unit and the second lifting device, wherein the control device of the second lifting device is configured to transmit the identification code from the first storage device to the mobile storage unit and to receive the identification code of the first lifting device and the identifier of the radio channel from the mobile storage unit and to store them in the second storage device, and the operator can disconnect the data connection to the second lifting device after a reception, whereupon the control device of the second lifting device transmits the identification codes stored in the first and second storage device via the selected radio channel.

11. A method for wirelessly coupling at least two lifting devices to form a lifting assembly that comprises the at least two lifting devices, the method comprising:
establishing a communication connection between a first lifting device and a mobile storage unit;
transmitting an identification code, which is stored in the first storage device of the lifting device disconnect to the mobile storage unit,
disconnecting the communication connection between the first lifting device and the mobile storage unit;
establishing a communication connection between an th lifting device and the mobile storage unit;
transmitting the identification code which is stored in the first storage device of an Nth lifting device to the mobile storage unit;
receiving the identification codes, which are stored in the mobile storage unit, and storing the received identification codes in a second storage device of the th lifting device;
disconnecting the communication connection between the th lifting device and the mobile storage unit; and
terminating a coupling mode and transmitting the identification codes, which are stored in the first and second storage device of the Nth lifting device.
